(19) United States
(12) Patent Application Publication
(10) Pub. No.: US 2004/0156206 A1
(43) Pub. Date: Aug. 12, 2004

(54) Light emitting rear-view mirror structure

(76) Inventor: Yen-Chun Lin, Taipei (TW)

Correspondence Address: BIRCH STEWART KOLASCH & BIRCH, PO BOX 747, FALLS CHURCH, VA, 22040-0747, US

(21) Appl. No.: 10/360,654

(22) Filed: Feb. 10, 2003

(51) Int. Cl. B60Q 1/00

(52) U.S. Cl. 362/487

(57) ABSTRACT

An improved light emitting rear-view mirror structure comprises a light emitting device installed in the front of a casing of the rear-view mirror of a motor vehicle; characterized in that said casing of the rear-view mirror at its front end comprises at least one transversal long protruded base; a long lamp cover with a special stylish design disposed on said long protruded base; and a light emitting device disposed in said long lamp cover. Since said casing of the rear-view mirror has a protruded long lamp cover installed at the front end of said casing to give a larger and longer light emitting surface at the front end of the rear-view mirror, therefore such structure has a better warning effect.

### BACKGROUND OF THE INVENTION

1. Field of the Invention

The present invention relates to an improved light emitting rear-view mirror structure, more particularly to a casing of a rear-view mirror of a motor vehicle having at least one transversal long protruded base and a long lamp cover and a light emitting device installed onto the protruded base, such that the rear-view mirror has a longer and larger light emitting surface and gives a better warning effect.

2. Description of the Related Art

In general, a driver drives a motor vehicle without turning on the headlight or fog light at dusk; it will not cause much trouble when driving in a straight rod in the urban area since there is still some light and has better alertness in the urban area. However, if the motor vehicle is driven on the narrow and zigzag roads in the mountain, it may cause accident more easily due to the poor vision in the weak light condition if the headlight or fog light is not turned on.

Furthermore, the fog light of a motor vehicle is installed at the four corners of a motor vehicle. Although the fog light gives a light dragging effect while the motor vehicle is in motion, the fog light is a static warning with respect to the relative speed. Therefore, its application as a warning effect to the coming cars is very limited, particularly on the narrow road at nighttime. Moreover, although the fog light is installed at the comers of the motor vehicle, the fog light is proximate the front end or the rear end, and thus giving no warning effect on both lateral sides of the motor vehicle.

Further, the fog light is generally installed flatly at four corners of a motor vehicle, therefore the warning effect is poor, particularly when driving on a narrow road at nighttime, the rear-view mirror will not be found by the car approaching from the front, and thus easily causing collisions or accidents. To overcome the shortcoming of not easy to have a clear view at the rear-view mirror at nighttime, a small warning light is installed in the front side of the rear-view mirror as shown in FIGS. 5 and 6. In the figures, a lamp socket a11 is disposed at the front side of a casing a1 of a rear-view mirror a; a lamp cover a2 is installed onto the lamp hole a11, and the lamp cover a2 flatly attached onto the casing 11, and a bulb b is installed onto the lamp socket a11, so that the rear-view mirror a can have a significant reminding and warning effect to catch the attention of the approaching cars.

However, the lamp cover a2 is flatly attached onto the casing a1 of the rear-view mirror, the light produced by the bulb b can only cover a limited range, and only has the planar lighting effect. There are blind spots while making turns at intersections, which cannot be viewed by the approaching cars from the opposite direction. Therefore the warning effect is very limited and needs improvement.

In view of the aforementioned shortcomings of the warning light at the front side of the prior-art rear-view mirror, the present inventor herein with many years in the related field enhanced the structure and invented the improved light emitting rear-view mirror structure of the present invention. The present invention a light emitting device installed in the front of a casing of the rear-view mirror of a motor vehicle; characterized in that said casing of the rear-view mirror at its front end comprises at least one transversal long protruded base; a long lamp cover with a special stylish design disposed on said long protruded base; and a light emitting device disposed in said long lamp cover. Since said casing of the rear-view mirror has a protruded long lamp cover installed at the front end of said casing to give a larger and longer light emitting surface at the front end of the rear-view mirror, therefore such structure has a better warning effect.

### SUMMARY OF THE INVENTION

The primary objective of this invention is to provide a rear-view mirror of a motor vehicle having at least a transversal long protruded base at the front side of the rear-view mirror, a long lamp cover and a light emitting device on the casing to give a larger and longer light emitting surface and a better warning effect.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the rear-view mirror being installed on a motor vehicle according to the present invention.

FIG. 2 is a perspective diagram of the disassembled parts of the present invention.

FIG. 3 is a cross-sectional diagram of the assembled structure of the present invention.

FIG. 4 is a cross-sectional diagram of the assembled structure of another preferred embodiment of the present invention.

FIG. 5 is a perspective diagram of a prior-art rear-view mirror installed on a motor vehicle.

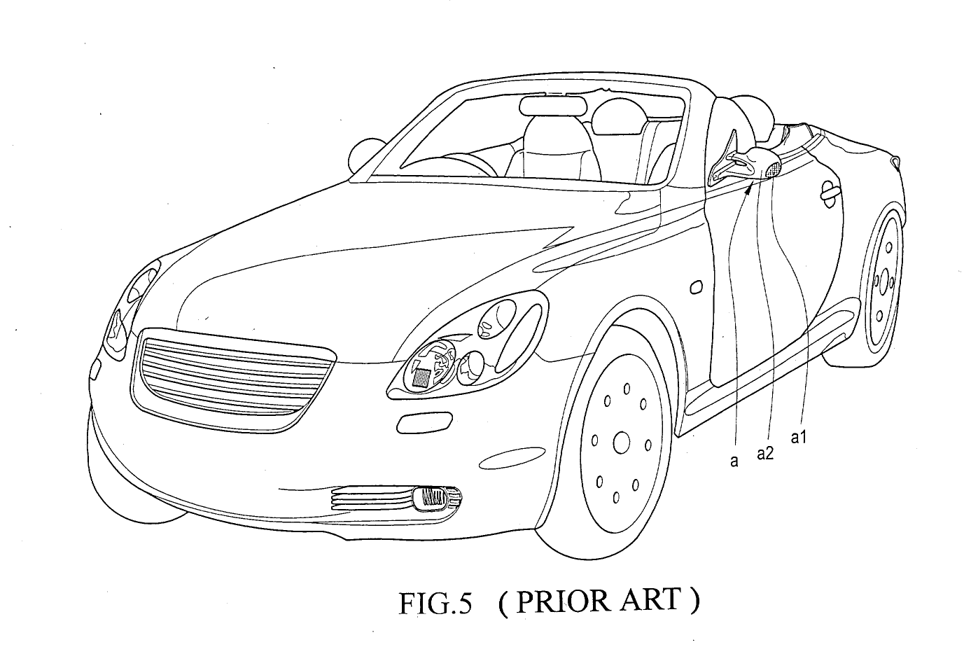

FIG. 6 is a perspective diagram of a prior-art assembled rear-view mirror.

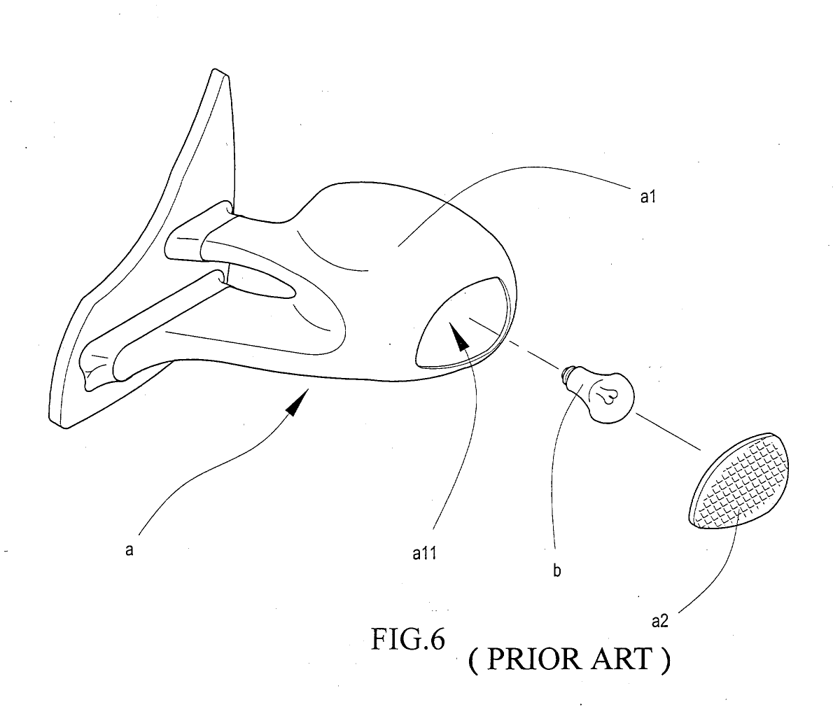

### DETAILED DESCRIPTION OF THE PREFERRED EMBODIMENTS

In the detailed description of the preferred embodiments, it should be noted that like elements are indicated by the same reference numerals throughout the disclosure.

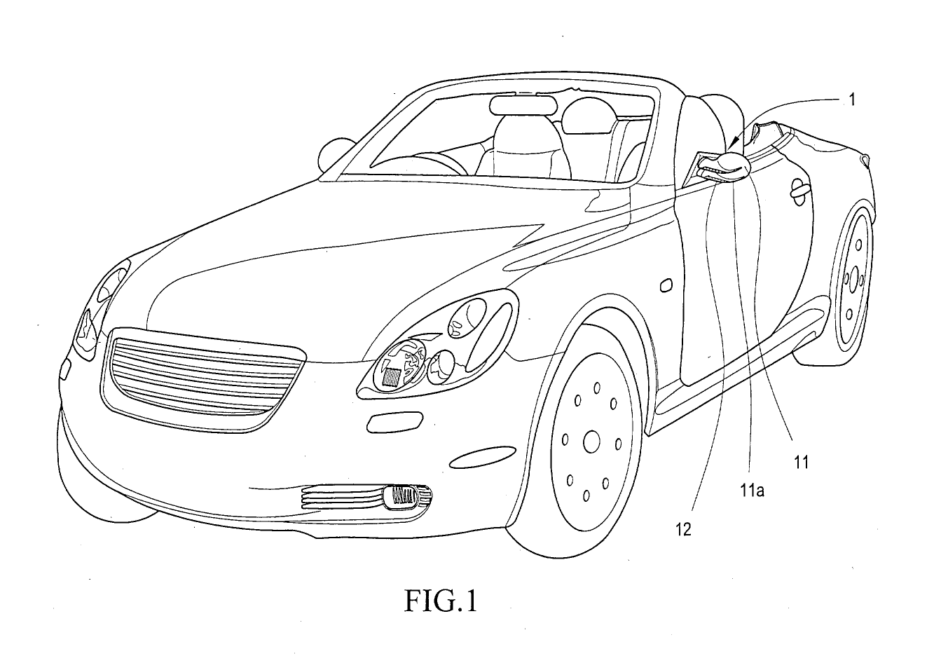

Refer to FIGS. 1, 2, and 3 for the structure of the present invention; a light emitting device 2 is installed at the front side of a casing 11 of a rear-view mirror of a motor vehicle, characterized in that at least one transversal long protruded base 11a; a long lamp cover 12 with a special stylish design disposed on said long protruded base 11a; and a light emitting device 2 disposed in said long lamp cover 12. Since said casing 11 of the rear-view mirror 1 has a protruded long lamp cover 12 installed at the front end of said casing 11 to give a larger and longer light emitting surface at the front end of the rear-view mirror 1, therefore such structure has a better reminding and warning effect than the prior-art flat light emitting rear-view mirrors

Furthermore, since the rear-view mirror 1 has at least one 3D light emitting surface at the front side of the rear-view mirror, it gives a bigger light dragging effect while the motor vehicle is in motion. Therefore, the present invention gives a better warning effect to remind the motor vehicles approaching from the opposite direction or the same direction and enhance the safety of driving.

Further, the front side of the rear-view mirror 1 at its front side has at least one 3D light emitting surface to eliminate the blind spot when making turns at the intersections and surely remind the approaching car from the opposite direction.

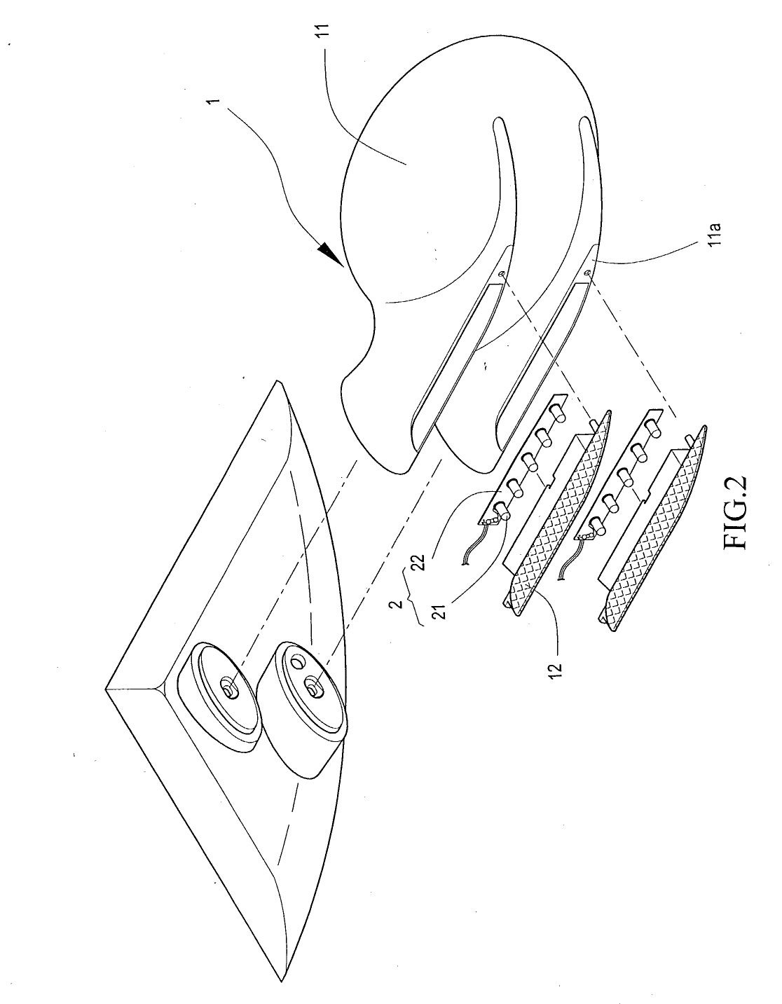

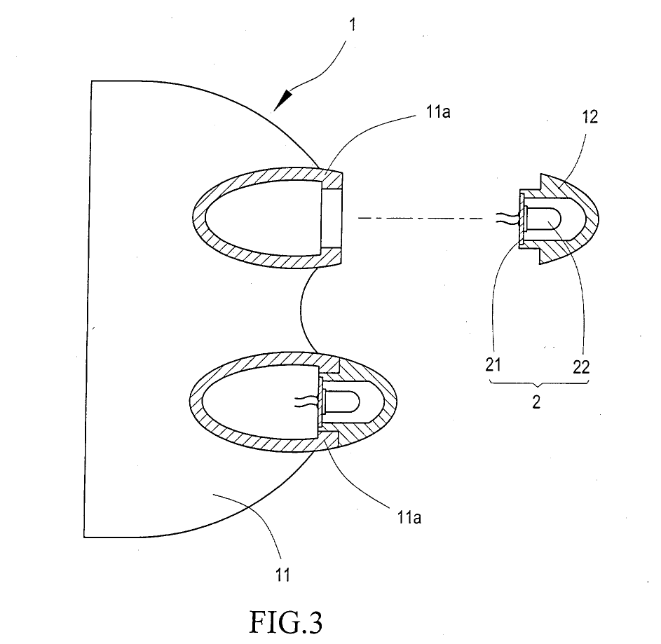

Please refer to FIGS. 2 and 3. The light emitting device 2 is comprised of a plurality of light emitting diodes 22 installed on a circuit board 2, such that the long lamp cover 12 consists of a row of light emitting diodes, and gives an overall light emitting effect to the long lamp cover 12. This is one of the embodiments of the light emitting diode of the present invention for your reference.

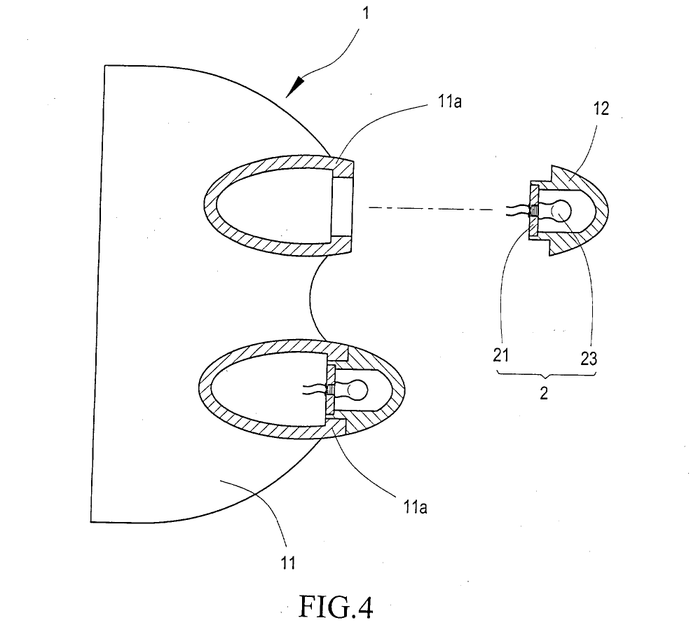

Please refer to FIG. 4. The light emitting device 2 is comprised of a plurality of bulbs 23, which can achieve the same effect as described above. This is another embodiment of the light emitting diode of the present invention for your reference. Further, the light emitting device 2 is controlled by an On/Off switch in the car such that the light emitting device 2 can be controlled separately, or the light emitting device 2 is connected to the circuit of the headlight, signal light, or fog light of a car to control the light emission of the light emitting device 2 synchronously.

In summation of the above description, the present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved light emitting rear-view mirror structure, having a light emitting device installed in the front side of a casing of a rear-view mirror of a motor vehicle, characterized in that:
at least one transversal protruded base protruded from the front side of a casing of a rear-view mirror; a long lamp cover with a specific stylish design disposed on said protruded base; and a light emitting device disposed in said long lamp cover.

2. The improved light emitting rear-view mirror structure of claim 1, wherein said light emitting device is comprised of a plurality of light emitting diodes installed on a circuit board.

3. The improved light emitting rear-view mirror structure of claim 1, wherein said light emitting device is comprised of a plurality of bulbs.

4. The improved light emitting rear-view mirror structure of claim 1, wherein said light emitting device is controlled by an ON/OFF switch and separately controlled by said light emitting device.

5. The improved light emitting rear-view mirror structure of claim 1, wherein said light emitting device is connected to the circuit of a headlight, signal light, or fog light to synchronously control the light emitting device.
